(19) United States
(12) Patent Application Publication
(10) Pub. No.: US 2018/0101750 A1
(43) Pub. Date: Apr. 12, 2018

(54) LICENSE PLATE RECOGNITION WITH LOW-RANK, SHARED CHARACTER CLASSIFIERS

(71) Applicant: Xerox Corporation, Norwalk, CT (US)

(72) Inventor: Albert Gordo Soldevila, Grenoble (FR)

(73) Assignee: Xerox Corporation, Norwalk, CT (US)

(21) Appl. No.: 15/290,561

(22) Filed: Oct. 11, 2016

(51) Int. Cl. G06K 9/46; G06F 17/30; G06N 3/08

(52) U.S. Cl. CPC G06K 9/4671; G06F 17/3028; G06K 2209/15; G06K 2209/01; G06N 3/08

(57) ABSTRACT

A method is disclosed for performing multiple classification of an image simultaneously using multiple classifiers, where information between the classifiers is shared explicitly and is achieved with a low-rank decomposition of the classifier weights. The method includes applying an input image to classifiers and, more particularly, multiplying the extracted input image features by |Σ| embedding matrices Ŵc to generate a latent representation of d-dimensions for each of the |Σ| characters. The embedding matrices are uncorrelated with a position of the extracted character. The step of applying the extracted character to the classifiers further includes projecting the latent representation with a decoding matrix shared by all the character embedding matrices to generate scores of every character in an alphabet at every position. At least one of the multiplying the extracted input image features and the projecting the latent representation with the decoding matrix are performed with a processor.

### BACKGROUND

The present disclosure is directed to low-rank, shared character classifiers. It finds particular application in conjunction with license plate recognition (LPR), and will be described with particular reference thereto. However, it is to be appreciated that the present exemplary embodiment is also amenable to other like applications, such as general text recognition in images.

Currently, convolutional neural networks (“deep convolutional network”, “CNNs”, “NNs” or “ConvNets”) can be used to perform lexicon-free text recognition. FIG. 1 shows an example of the architecture of a character CNN used for license plate recognition in the PRIOR ART. In the existing CNN, convolving of an input image with learned filters generates a stack of activations. Each stack of activations can undergo additional convolutions with more filters to generate a new stack. In one embodiment, the activations can be further fed through a series of fully-connected layers to produce more activations. These activations are unfolded into a feature vector that is fed to a set of classifiers used to predict the character at each position of the license plate. The classifiers can be implemented using more fully-connected layers that become part of the CNN. In other words, CNNs can simultaneously learn features to represent text in images and, using character classifiers, generate a probability of obtaining a given character of an alphabet at a given position in the transcription.

The character classifiers currently used for text recognition predict a probability of obtaining a given character c of an alphabet Σ at a given position p in the transcription. A maximum length of the potential transcription is fixed in advance. In this manner, multiple classifiers are used for the same character, one for each position, but each classifier is independent of the others. There can be a different classifier for each position of a given character. For example, a character can have a first classifier at a first position, a second classifier at a second position, and so forth. FIGS. 2A-C illustrate example license plates each including the alpha character “A”, but shown in each figure at a different character position. Each of those “A” characters would be recognized by a different classifier. The classifiers are learned jointly and operate over the same image signature, but they do not share information. Therefore, the classifier for a character at one position does not share knowledge with the classifiers for the same character at different positions.

Minor improvements can also be obtained by enforcing bigram consistency or by using recurrent networks such as long short-term memory networks (LSTMs) to output a sequence of characters, which does not require a maximum length of the transcription to be provided.

Mainly, the CNNs are used to learn the features in an end-to-end manner. However, one disadvantage of CNNs is the large amounts of data needed to effectively train the CNN, which makes them difficult to use for the task of license plate recognition. However, the existing CNN can be trained to perform generic text recognition using available text data, and then the neural network can be fine-tuned to perform the more specific task of license plate recognition. This approach improves over the previous LPR systems. However, it still requires several thousand annotated license plates for training the CNN. To generate the highest quality results, every possible character-position pair has to be seen several times during the fine-tuning stage. The more frequently that character-position pairs are seen during training is proportional to the accuracy of classification. In other words, misclassifications are more common for pairs that are less frequently observed during training.

Thus, there exists a challenge in obtaining a sizable sample of annotated license plate images where every possible combination of character-position pairs appears multiple times in the dataset of sample images. A method for license plate recognition is desired that leverages the power of CNNs, but does not require a large amount of annotated license plate images. An approach is therefore desired which shares information between classifiers of the same character at different positions to improve the efficacy of training of the character classifiers, particularly where limited training samples are available, and to improve the accuracy of the trained classifiers.

### INCORPORATION BY REFERENCE

The disclosure of co-pending and commonly assigned US Published Application No. 14/972481 entitled, “COARSE-TO-FINE CASCADE ADAPTATIONS FOR LICENSE PLATE RECOGNITION WIT CONVOLUTIONAL NEURAL NETWORKS”, filed Dec. 17, 2015 by Albert Gordo, et al., is totally incorporated herein by reference.

The disclosure of co-pending and commonly assigned US Published Application No. 14/794497 entitled, “LEXICON-FREE MATCHING-BASED WORD-IMAGE RECOGNITION”, filed Jul. 8, 2015 by Albert Gordo, et al., is totally incorporated herein by reference.

The disclosure of M. Jaderberg, et al., titled “SYNTHETIC DATA AND ARTIFICIAL NEURAL NETWORKS FOR NATURAL SCENE TEXT RECOGNITION”, NIPS DLRL Workshop, 2014, is totally incorporated herein by reference.

### BRIEF DESCRIPTION

In one embodiment of the disclosure, a method is disclosed for performing multiple classification of an image simultaneously using multiple classifiers, where information between the classifiers is shared explicitly and is achieved with a low-rank decomposition of the classifier weights. The method includes acquiring an input image and extracting a feature representation from the input image. The method includes applying the extracted feature representation to classifiers. The step of applying the extracted feature representation to the classifiers includes multiplying the extracted feature representation by |Σ| embedding matrices Ŵc to generate a latent representation of d-dimensions for each of the |Σ| characters, where |Σ| denotes the size of Σ. The embedding matrices are uncorrelated with a position of the extracted character. The step of applying the extracted feature representation to the classifiers further includes projecting the latent representation with a decoding matrix shared by all the character embedding to generate scores of every character in an alphabet at every position. At least one of the multiplying the extracted feature representation from the input image and the projecting the latent representation with the decoding matrix are performed with a processor.

In one embodiment of the disclosure, a system is disclosed for performing multiple classification of an image simultaneously using multiple classifiers, where information between the classifiers is shared explicitly and is achieved with a low-rank decomposition of the classifier weights. The system includes a processor and a non-transitory computer readable memory storing instructions that are executable by the processor. The processor is operative to acquire an input image and extract a feature representation from the input image. The processor is further operative to applying the extracted feature representation to at least one classifier. The system further includes a classifier. The classifier includes |Σ| embedding matrices Ŵc each uncorrelated with a position of the extracted character and a decoding matrix shared by all the character embedding matrices. The processor multiplies the extracted feature representation of the input image by the |Σ| embedding matrices Ŵc to generate a latent representation of d-dimensions for each of the |Σ| characters. The processor projects the latent representation with the decoding matrix to generate scores of every character in an alphabet at every position.

### BRIEF DESCRIPTION OF THE DRAWINGS

FIG. 1 shows an example of the CNN architecture used for text recognition in the PRIOR ART.

FIGS. 2A-C illustrates example license plates with a character “A” shown in different positions.

FIG. 3 shows an overview of a method in the PRIOR ART for learning L independent |Σ|-way classifiers.

FIG. 4 shows a low-rank decomposition of classifiers into position-independent and character-independent parts.

FIG. 5 is a schematic showing a computer-implemented system for performing license plate recognition with low-rank, shared, character classifiers.

FIG. 6 illustrates and exemplary method which may be performed with the system of FIG. 5.

FIGS. 7A-D shows the improvement in recognition rate for the character-position pairs as a function of a number of training samples for a specific character-position pair.

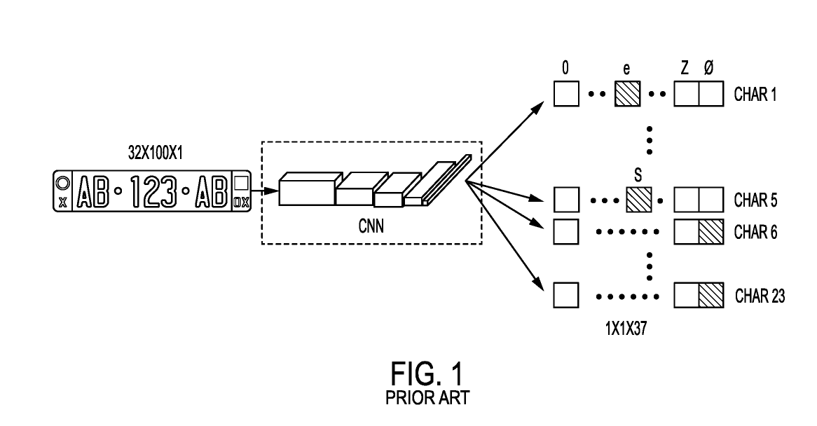

### DETAILED DESCRIPTION

The present disclosure is directed to low-rank, shared character classifiers. The architecture of a character CNN is modified to share information between the classifiers of a same character at different positions. Mainly, a classifier that does not have sufficient data for a given position receives information from classifiers of the same character at different positions where more training data is available. The modified architecture is achieved by enforcing a low-rank decomposition of the character-position classifiers to learn different character parts and a position part, and where the position part is shared between different character parts. This modification is achieved by removing the original classifiers and adding layers, discussed infra, to the network, after the last fully-connected layer.

As used herein, a license plate configuration can include an alpha-numeric series. A character can include a letter, a number, or a null character (which is ignored). A letter is also referred to herein as an alpha character. A number is also referred to herein as a numeric character. A blank space in a string or series of characters is referred to as a null character. An n digit series includes n character positions, where a letter is referred to, for example, as being at the i^{th} alpha position or character position. For illustrative purposes, the maximum length L of a potential transcription is referred to herein as being twenty-three (23) characters.

In the existing architecture, the output of the last fully-connected layer produces a feature vector representation f(I), of D=4,096 dimensions that represents the input image I. The dimensional output of this first part of the network is then fed into the L×|Σ| independent character-position (c,p) classifiers, : w_{c,p ∈} [symbol] ^{D}, where a score is computed as the dot product, i.e., S_{c,p}(I)=w_{c,p}^{T}f(I). In the existing CNN architecture, the L positions are fixed in advance, such as, in the illustrative example, to 23 characters. The number of classifiers (37) refers to a number of symbols in the alphabet |Σ|=37. The typical alphabet includes the 26 letters/alpha characters of the English alphabet, 10 digits/numeric characters, and a null character). By taking the character with a maximum score at each position, a transcription of a word image can be computed. However, the disclosure is not limited to this particular alphabet and is amenable to the application of other alphabets where sufficient training data is available.

To obtain the transcription of a word or text string, the character with the maximum score is extracted at every position using the equation:

$$T ( I ) = \{ {argmax}_{c} {S}_{c , 1} ( I ) , {argmax}_{c} {S}_{c , 2} ( I ) , … , {argmax}_{c} {S}_{c , L} ( I ) \}$$

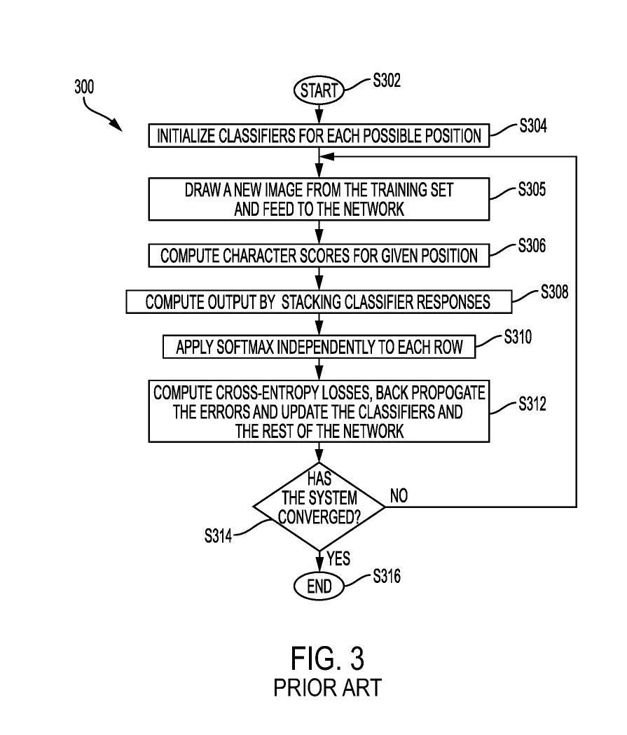

FIG. 3 shows an overview of a method 300 for learning L independent |Σ|-way classifiers in the PRIOR ART. The method starts at S302. A classifier is initialized randomly for each possible position at S304. A new image is drawn from the training set and fed into the network at S305. At S306, for a sampled image, the character scores for a given position are computed using the equation: Sₚ(I)=Wₚ^{T}f(I), Sₚ: I→ [symbol] ^{|Σ|}, where Wₚ is a concatenation of the different character-position classifiers w: wₚ=[w_{1,p}, w_{2,p}, w_{3,p}, . . . , W_{36,p}], of size 36×D. By stacking the responses of the L classifiers, an output of size L×|Σ| is computed at S308. The output contains the scores of the 37 characters |Σ| at the L=23 positions. At S310, a softmax is then applied independently to each row, making the responses of different characters at the same position comparable. During the training, the L independent cross-entropy losses are computed and are back propagated through the rest of the network at S312. The back propagation produces gradients, i.e., information to improve the model. These gradients are used to update the weights of the classifiers (and of all the previous layers) to create the improved model. At S314, a determination is made whether the system has converged. In response to the system not converging (NO at S314), the process returns to S305, samples a new image, and repeats until the model is sufficient. In response to the system converging (YES at S314), the method ends at S316.

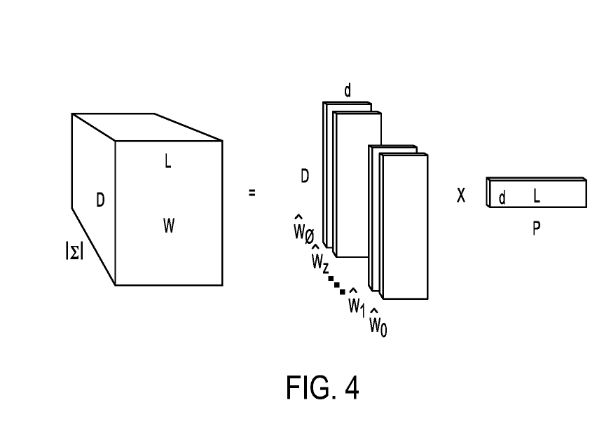

Illustrated in FIG. 4, all the character-position classifiers can be observed as a tensor W ∈ [symbol] ^{D×L×|Σ|}. By slicing the tensor W along an orthogonal axis, the different W_{c}∈ [symbol] ^{D×L} classifiers are obtained. The different Wc classifiers are learned simultaneously together with f, which allows them to share, implicitly, some information between them. However, there is no explicit information sharing between the classifiers at different positions, which can help in the case where limited training data is available for some characters at some positions. To force the classifiers to share information, W is decomposed into |Σ| embedding matrices Ŵc that project the representation of the image f(I) into a d-dimensional space that contains information about character c, uncorrelated with the specific position of the character in I, and into a single decoder P, shared by all characters. The combination of the Ŵc matrices and the decoder P constitute a low-rank approximation of the original classifiers, and generate a prediction corresponding to how likely each particular character appears in all possible positions.

This method affects all classifiers at all positions, including those for which little training data has been observed. As all these changes involve standard operations where the backpropagation is well defined, the weights of these layers can also be learned. The weights of the rest of the network can also be updated to better fit them.

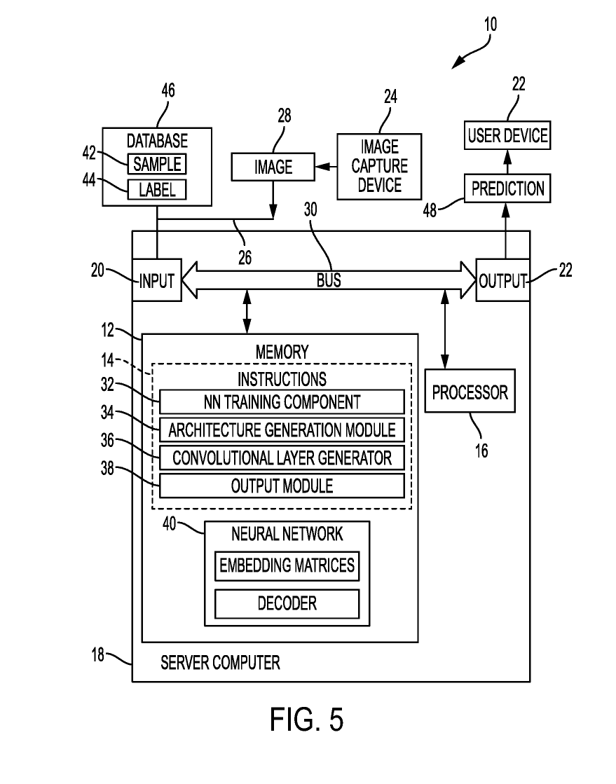

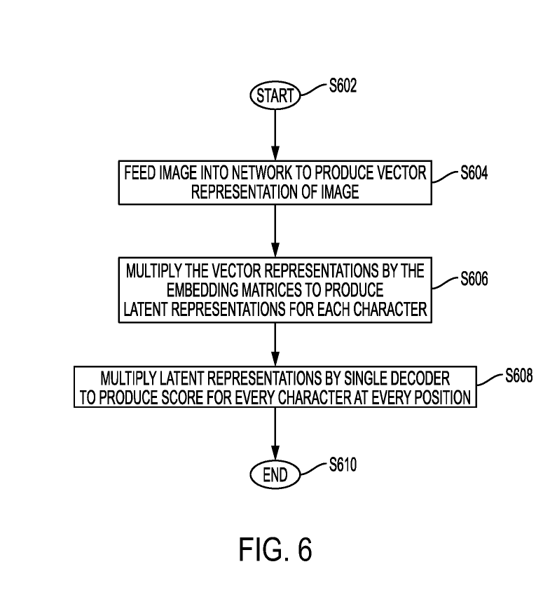

With reference to FIG. 5, a computer-implemented system 10 for performing license plate recognition with low-rank, shared character classifiers is shown. The system 10 includes memory 12 which stores instructions 14 for performing the method illustrated in FIGS. 3 and 6 and a processor 16 in communication with the memory for executing the instructions. The system 10 may include one or more computing devices 18, such as the illustrated server computer. One or more input/output devices 20, 22 allow the system to communicate with external devices, such as an image capture device 24, or other source of an image, via wired or wireless links 26, such as a LAN or WAN, such as the Internet. The image capture device 24 may include a camera, which supplies the images of license plates 28 to the system 10 for processing. Hardware components 12, 16, 20, 22 of the system 20 communicate via a data/control bus 30.

The illustrated instructions 14 include a neural network training component 32, an architecture generation module 34, a convolutional layer generation module 36, and an output component 38.

The NN training component 32 trains the neural network 40. The neural network includes an ordered sequence of supervised operations (i.e., layers) that are learned on a set of labeled training objects 42, such as sample images and their true labels 44. In an illustrative embodiment, where the input image 26 includes a license plate, the set of labeled training images 42 comprises a database of images of intended objects each labeled to indicate a type using a labeling scheme of interest (such as class labels corresponding to the object of interest). Fine-grained labels or broader class labels are contemplated. The supervised layers of the neural network 40 are trained on the training sample images 42 and their labels 44 to generate a prediction 48 (e.g., in the form of character-position pair probabilities) for a new, unlabeled image 28, such as that of a license plate. In some embodiments, the neural network 40 may have already been pre-trained for this task and thus the training component 32 can be omitted.

The architecture generation module 34 prepares the neural network architecture, including the low-rank classifiers to enable information to be shared between classifiers of the same character at different positions.

The module 36 embeds the input feature into a low-dimensional space that is related to the particular character c but not to any specific position, where a decoder is shared between the different characters. The output of this layer is a matrix.

The output component 38 outputs information, such as the predictions 50 of the image 28 data for each character-position in the captured license plate or text image.

The computer system 10 may include one or more computing devices 18, such as a PC, such as a desktop, a laptop, palmtop computer, portable digital assistant (PDA), server computer, cellular telephone, tablet computer, pager, camera 24, combinations thereof, or other computing device capable of executing the instructions for performing the exemplary method.

The memory 12 may represent any type of non-transitory computer readable medium such as random access memory (RAM), read only memory (ROM), magnetic disk or tape, optical disk, flash memory, or holographic memory. In one embodiment, the memory 12 comprises a combination of a random access memory and read only memory. In some embodiments, the processor 16 and memory 12 may be combined in a single chip. Memory 12 stores instructions for performing the exemplary method as well as the processed data 42, 44.

The network interface 20, 22 allows the computer to communicate with other devices via a computer network, such as a local area network (LAN) or wide area network (WAN), or the internet, and may comprise a modulator/demodulator (MODEM), a router, a cable, and/or Ethernet port.

The digital processor device 16 can be variously embodied, such as by a single-core processor, a dual-core processor (or more generally by a multiple-core processor), a digital processor and cooperating math coprocessor, a digital controller, or the like. The digital processor 16, in addition to executing instructions 14 may also control the operation of the computer 18.

The term “software,” as used herein, is intended to encompass any collection or set of instructions executable by a computer or other digital system so as to configure the computer or other digital system to perform he task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

FIG. 6 illustrates and exemplary method which may be performed with the system of FIG. 5. The method starts at S602. At S604, an image is fed into the network, and the first convolutional and fully connected layers produce a vector representation f(I), of D dimensions, of the image I. At S606, this representation of the image is multiplied by the |Σ| embedding matrices Ŵc. This multiplication produces a latent representation of d dimensions for each of the |Σ| characters that is independent of its position. At S608, these latent representations are multiplied by the single decoder P, which produces the score of every character in the alphabet at every one of the L positions. The method ends at S610.

Although the control method is illustrated and described above in the form of a series of acts or events, it will be appreciated that the various methods or processes of the present disclosure are not limited by the illustrated ordering of such acts or events. In this regard, except as specifically provided hereinafter, some acts or events may occur in different order and/or concurrently with other acts or events apart from those illustrated and described herein in accordance with the disclosure. It is further noted that not all illustrated steps may be required to implement a process or method in accordance with the present disclosure, and one or more such acts may be combined. The illustrated methods and other methods of the disclosure may be implemented in hardware, software, or combinations thereof, in order to provide the control functionality described herein, and may be employed in any system including but not limited to the above illustrated system 10, wherein the disclosure is not limited to the specific applications and embodiments illustrated and described herein.

The method illustrated in FIG. 6 may be implemented in a computer program product that may be executed on a computer. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other non-transitory medium from which a computer can read and use. The computer program product may be integral with the computer 18, (for example, an internal hard drive of RAM), or may be separate (for example, an external hard drive operatively connected with the computer 18), or may be separate and accessed via a digital data network such as a local area network (LAN) or the Internet (for example, as a redundant array of inexpensive or independent disks (RAID) or other network server storage that is indirectly accessed by the computer 18, via a digital network).

Alternatively, the method may be implemented in transitory media, such as a transmittable carrier wave in which the control program is embodied as a data signal using transmission media, such as acoustic or light waves, such as those generated during radio wave and infrared data communications, and the like.

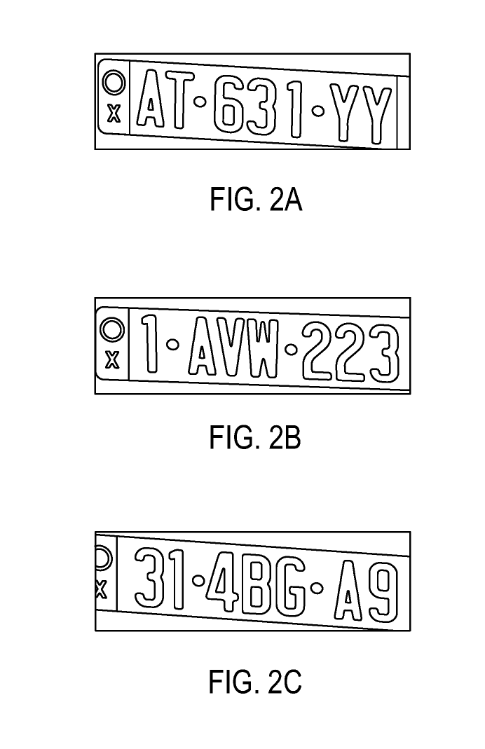

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the flowchart shown in FIG. 2, can be used to implement the method. As will be appreciated, while the steps of the method may be computer implemented, in some embodiments one or more of the steps may be at least partially performed manually. As will also be appreciated, the steps of the method need not all proceed in the order illustrated and fewer, more, or different steps may be performed.

### EXAMPLES

The performance of the low-rank shared classifiers was evaluated using three datasets. A first dataset (the Oxford Synthetic dataset) includes synthetic text images used for training. Because the first dataset contains only words from a dictionary, characters are much more common than digits, which are underrepresented. A model learned solely on this dataset is expected to perform poorly on the task of license plate recognition, both because of the domain drift and because of the lack of images with digits. However, training a CNN on this dataset and then adapting it to the task of license-plate recognition leads to improved results.

The second (Wa-dataset) and third (Cl-dataset) datasets includes captured license plate images. The Wa-dataset (Wa) contains 4,215 training images and 4,215 testing images, with 3,282 unique license plates. These license plates have been automatically localized and cropped from images capturing the whole vehicle, and an automatic perspective transformation has been applied to straighten them. Poor detections were manually removed, but license plates that were partly cropped, misaligned, badly straightened, or including other problems were maintained in the dataset. The CI-dataset (CI) contains 2,867 training images and 1,381 testing images, with 1,891 unique license plates captured in a similar manner than in the Wa-dataset but in a different site. However, in general, the quality of the license plate images of the CI-dataset suffers from more problems due to poor detections or misalignments.

Network Architecture and Training:

The baseline network is based on the CHAR+2 network disclosed by M. Jaderberg, et al., in “SYNTHETIC DATA AND ARTIFICIAL NEURAL NETWORKS FOR NATURAL SCENE TEXT RECOGNITION”, NIPS DLRL Workshop, 2014, which is totally incorporated herein by reference.

The network takes as input gray images resized to 32×100 pixels (without preserving the aspect ratio) and runs them through a series of convolutions and fully-connected layers. The output of the network is a matrix of size 37×L, with (an assumed maximum length of) L=23, where every cell denotes the probability of finding each of the 37 possible symbols (10 digits, 26 characters, and the NULL symbol) at position 1, 2, . . . , L in the license plate. Given the output of a network, the transcription can be obtained by moving through the L columns and taking the symbol with the highest probability in each column.

The exact architecture of the network was a conv64-5, conv128-5, conv256-3, conv512-3, conv512-3, fc4096, fc4096, fc(37×23), where convX-Y denotes a convolution with X filters of size Y×Y, and fcX was a fully-connected layer which produces an output of X dimensions. The convolutional filters have a stride of 1 and are padded to preserve the map size. A max-pooling of size 2×2 with a stride of 2 follows convolutional layers 1, 2, and 4. ReLU non-linearities are applied between each pair of layers. The network ended in 23 independent classifiers (one for each position) that performed a softmax and used a cross-entropy loss for training. Although the classifiers are independent of each other, they were trained jointly together with the remaining parameters of the network.

The network was trained with SGD with momentum of 0.9, fixed learning rate of 5·10⁻⁵ and weight decay of 5·10⁻⁴, with minibatches of size 128. Following the approach disclosed in co-pending and commonly assigned US Published Application No. 14/794497 entitled, “LEXICON-FREE MATCHING-BASED WORD-IMAGE RECOGNITION”, filed Jul. 8, 2015 by Albert Gordo, et al., the contents of which are totally incorporated herein by reference, the network was trained for several epochs on the first dataset until convergence of accuracy on a validation set, and then it was fine-tuned on the second and third datasets until the accuracy converged. Once the accuracy had approximately converged, the training was continued during 10 epochs and a model was snapshot at the end of each epoch. The final results are the average result of those 10 models.

Disclosed Low-Rank Network:

The network that was evaluated followed the same architecture up until the classification layer. The fc(37×23) layer was replaced by a fc(37*d) layer (which plays the role of Ŵc), a reshape layer, and a conv23-1 layer (which plays the role of the decoder P), which produced the 37×23 output. Several values of dimensions d were explored, from 6 to 16.

To train the disclosed low-rank network, the same approach was followed as used for training the baseline network. First, the low-rank network was trained on the first dataset and then fine-tuned on the second and third datasets. However, to speed up the training process, the weights of the initial convolutional layers were initialized with the values of the already trained full-rank baseline network, and only the classifier layers were learned from scratch.

### Results-Example 1

The disclosed method was evaluated in two scenarios. The first scenario focused on the accuracy of the rarest character-position pairs:

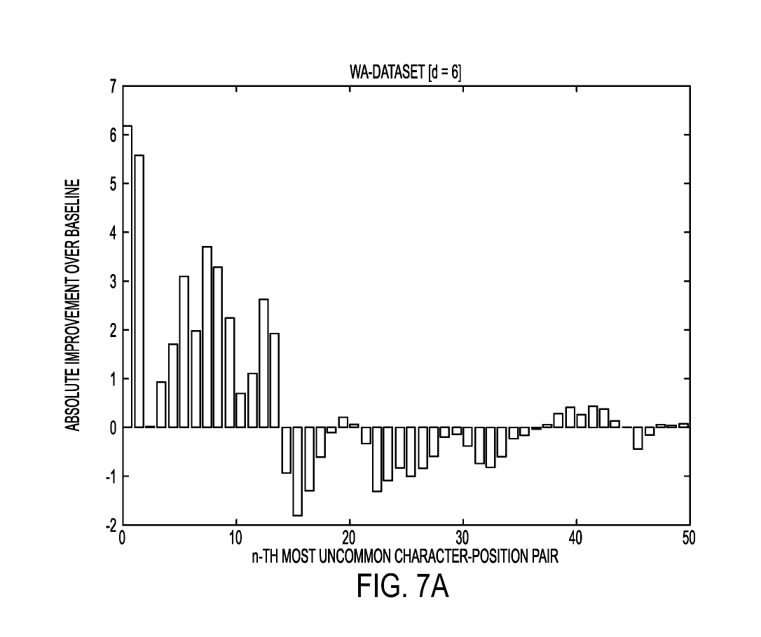

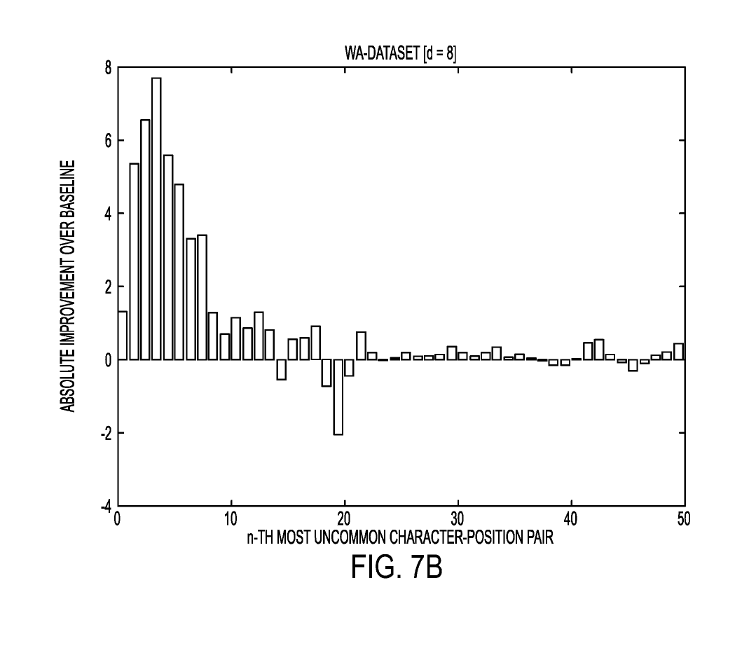

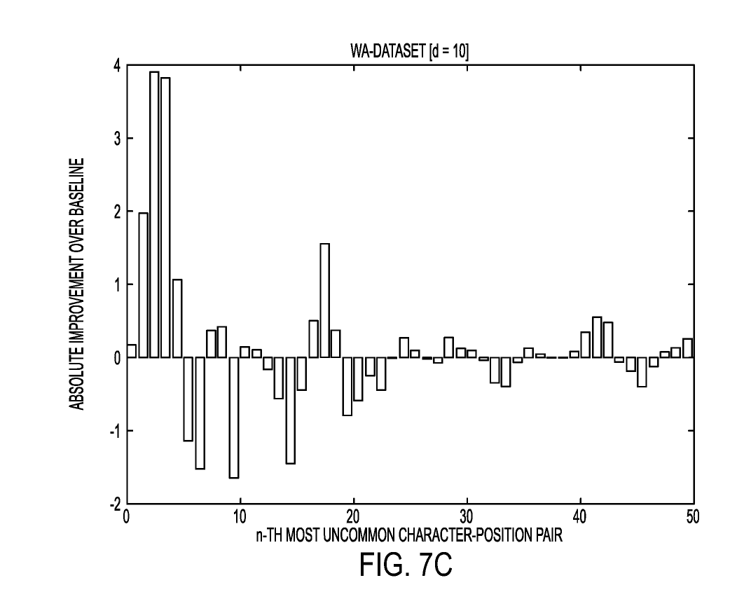

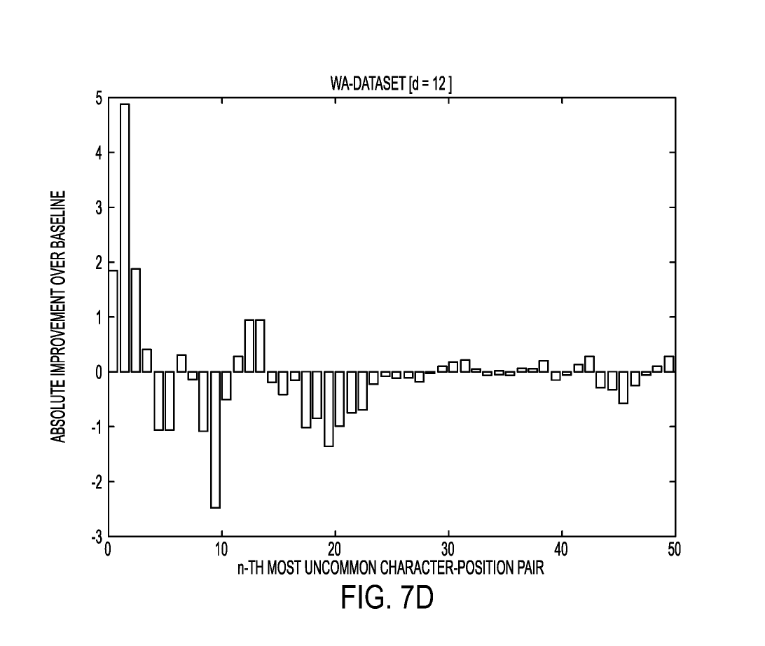

FIGS. 7A-D shows the absolute improvement in recognition rate of the disclosed low-rank network with respect to the full-rank baseline for the rarest character-position pairs for as a function of how rare the pair character-position was in the training set. To evaluate the effect of dimension d, different plots are shown for several values of d.

A low value of dimension d may lead to underfitting, while a high value may not bring any improvement over the full-rank baseline. This observation is corroborated in the next example, which focused on global accuracy.

### Global Accuracy-Example 2

In the second scenario, the global performance of the approach for license plate recognition was focused on, reporting both recognition accuracy and character error rate. In this example, the disclosed approach was evaluated on the task of license plate recognition. The results were compared against the full-rank baseline, as well as other existing approaches. Two measures of accuracy are reported. The first measures is the recognition rate (RR), which denotes the percentage of test license plates that were correctly recognized, and is a good estimator of the quality of the system. The second measure is the character error rate (CER), which denotes the percentage of characters that were classified incorrectly. This measure provides an estimation of the effort needed to manually correct the annotation. The results are shown in Table 1 for the second and third datasets.

TABLE 1

| | | Wa-dataset | | Cl-dataset | |
|---|---|---|---|---|---|
| | Model | CER ↓ | RR ↑ | CER ↓ | RR ↑ |
| (a) | OCR | 2.2 | 88.59 | 25.4 | 57.13 |
| (b) | U.S. Ser. No. | 2.1 | 90.05 | 7.0 | 78.00 |
| | 14/794,479 | | | | |
| (c) | Full rank | 1.000 ± | 95.86 ± | 4.078 ± | 86.51 ± |
| | U.S. Ser. No. | 0.015 | 0.06 | 0.050 | 0.21 |
| | 14/972,481 | | | | |
| (d) | Low rank (d = 6) | 0.954 ± | 95.67 ± | 4.285 ± | 86.41 ± |
| | | 0.025 | 0.09 | 0.051 | 0.13 |
| (e) | Low rank (d = 8) | 0.856 ± | 96.07 ± | 4.043 ± | 87.27 ± |
| | | 0.017 | 0.09 | 0.044 | 0.13 |
| (f) | Low rank (d = 10) | 0.924 ± | 95.94 ± | 4.014 ± | 87.33 ± |
| | | 0.012 | 0.06 | 0.043 | 0.18 |
| (g) | Low rank (d = 12) | 0.960 ± | 95.91 ± | 3.957 ± | 87.093 ± |
| | | 0.017 | 0.07 | 0.039 | 0.09 |

For both datasets, the proposed low-rank shared classifiers outperform the full-rank system in RR and CER when the correct value of dimension d was selected. As discussed supra, a low value of dimension d (e.g., “6”) leads to underfitting, while higher values of d (e.g., “12”) may reduce the gap between the proposed approach and the baseline. The optimal value of dimension d may be dataset-dependent: for the first dataset, d =8 was observed to work best, while for the second dataset, d=10 and d=12 worked best.

Improvements in RR and CER were not always correlated. In the first dataset, the disclosed approach leads to a reduction of the CER, and only an improvement on the RR. On the other hand, the RR on the third dataset improved significantly while the improvement in CER was limited. These observations were not surprising considering a substantial number of test images of the third dataset were wrong by only one character. As the overall recognition rate of third dataset was lower, small improvements in the CER lead to significant improvements in the RR.

The results demonstrate that one aspect of the disclosed method and system is improved global recognition and character error rates on license plate recognition.

Another aspect of the present disclosure is an improved accuracy of trained classifiers for license plate recognition and text recognition in general. The disclosure improves training for, and later classification of, the character-position pairs less commonly observed in a training set, thus improving the global recognition and character error rates.

Another aspect of the disclosed architecture is fewer parameters over existing networks.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method to perform multiple classification of an image simultaneously using multiple classifiers, where information between the classifiers is shared explicitly and is achieved with a low-rank decomposition of the classifier weights, the method comprising:
acquiring an input image;
extracting a representation from the input image;
applying the low-rank character classifiers to the extracted image representation, including:
multiplying the extracted image representation by |Σ| embedding matrices Ŵc to generate a latent representation of d-dimensions for each of the |Σ| characters, wherein the embedding matrices are uncorrelated with a position of the extracted character;
projecting the latent representation with a decoding matrix shared by all the character embedding matrices to generate scores of every character in an alphabet at every position;
wherein at least one of the multiplying the extracted representation from the input and the projecting the latent representation with the decoding matrix are performed with a processor.

2. The method of claim 1, wherein the decoding matrix is indicative of a probability that a given character is found at each position.

3. The method of claim 1 further comprising:
outputting a prediction corresponding to a probability that a particular character appears in each possible position of the input image.

4. The method of claim 3, wherein the outputting the prediction includes:
assigning a character label with a highest score at each position to the input image.

5. The method of claim 1, wherein the multiplying the input by |Σ| embedding matrices Ŵc includes:
projecting the input image into a different space of |Σ|×d-dimensions representing every character in the alphabet in a space of d-dimensions.

6. The method of claim 1, wherein the input image is a word image.

7. The method of claim 6, wherein the word image is a license plate.

8. The method of claim 7 further comprising:
determining a license plate configuration using character labels assigned at each possible position of the input image, wherein the each possible position in the word image is associated with one of a letter, a number, and a null character.

9. The method of claim 1 further comprising:
forcing the classifiers to share information by decomposing the classifiers into the |Σ| embedding matrices Ŵc and the decoding matrix P.

10. The method of claim 1 further comprising training the classifiers, including:
randomly initializing an embedding matrix for each possible position in a sample word image;
for the sample word image, computing character scores for a given character-position in the sample word image by projecting the extracted image representation into the latent space with Ŵc and then decoding the results with P;
independently applying a soft max to each row to make the output of different positional characters at a same position comparable;
computing cross-entropy losses;
back-propagating the computed losses through a neural network to generate gradients; and
updating weights of the embedding matrices using the gradients.

11. A system for performing multiple classification of an image simultaneously using multiple classifiers, where information between the classifiers is shared explicitly and is achieved with a low-rank decomposition of the classifier weights, the system comprising:
a processor; and
a non-transitory computer readable memory storing instructions that are executable by the processor to:
acquire an input image;
extract a character from the input image;
applying the extracted character to at least one classifier;
a classifier, including:

|Σ| embedding matrices Ŵc each uncorrelated with a position of the extracted character, wherein the processor multiplies the extracted input image representation by the |Σ| embedding matrices Ŵc to generate a latent representation of d-dimensions for each of the |Σ| characters; and,
a decoding matrix shared by all the character embedding matrices, wherein the processor projects the latent representation with the decoding matrix to generate scores of every character in an alphabet at every position.

12. The system of claim 11, wherein the decoding matrix is indicative of a probability that a given character is found at each position.

13. The system of claim 11, wherein the processor is further operative to:
output a prediction corresponding to a probability that a particular character appears in each possible position of the input image.

14. The system of claim 13, wherein the processor is operative to output the prediction by assigning a character label with a highest score at each position to the input image.

15. The system of claim 11, wherein the processor is operative to multiply the input by |Σ| embedding matrices Ŵc by projecting the input image into a different space of |Σ|×d-dimensions representing every character in the alphabet in a space of d-dimensions.

16. The system of claim 11, wherein the input image is a word image.

17. The system of claim 16, wherein the word image is a license plate.

18. The system of claim 17, wherein the processor is further operative to:
determine a license plate configuration using character labels assigned at each possible position of the input image, wherein the each possible position in the word image is associated with one of a letter, a number, and a null character.

19. The system of claim 11, wherein the processor is further operative to:
force the classifiers to share information by decomposing the classifiers into the |Σ| embedding matrices Ŵc and the decoding matrix P.

20. The system of claim 11 wherein the processor is further to train the classifiers, including:
randomly initializing an embedding matrix for each possible position in a sample word image;
for the sample word image, computing character scores for a given character-position in the sample word image by projecting the extracted image representation into the latent space with Ŵc and then decoding the results with P;
independently applying a soft max to each row to make the output of different positional characters at a same position comparable;
computing cross-entropy losses;
back-propagating the computed losses through a neural network to generate gradients; and
updating weights of the embedding matrices using the gradients.
